(19) United States
(12) Patent Application Publication
(10) Pub. No.: US 2017/0165835 A1
(43) Pub. Date: Jun. 15, 2017

(54) RAPIDLY-EXPLORING RANDOMIZING FEEDBACK-BASED MOTION PLANNING

(71) Applicant: QUALCOMM Incorporated, San Diego, CA (US)

(72) Inventors: Saurav AGARWAL, Bryan, TX (US); Aliakbar AGHAMOHAMMADI, San Diego, CA (US); Kiran SOMASUNDARAM, San Diego, CA (US)

(21) Appl. No.: 15/192,881

(22) Filed: Jun. 24, 2016

Related U.S. Application Data
(60) Provisional application No. 62/265,238, filed on Dec. 9, 2015.

(51) Int. Cl. B25J 9/16; G06N 99/00

(52) U.S. Cl. CPC B25J 9/1666; G06N 99/005; B25J 9/1664; B25J 9/163; Y10S 901/09; Y10S 901/01

(57) ABSTRACT

A method of motion planning for an agent to reach a target includes determining a frontier region between a frontier at a current time and a frontier at a next time. Waypoints are sampled in the frontier region with a bias toward the target. A path to reach the target is selected based on a sequence of the sampled waypoints.

### CROSS-REFERENCE TO RELATED APPLICATION

The present application claims the benefit of U.S. Provisional Patent Application No. 62/265,238, filed on Dec. 9, 2015, and titled “RAPIDLY-EXPLORING RANDOMIZING FEEDBACK-BASED MOTION PLANNING,” the disclosure of which is expressly incorporated by reference herein in its entirety.

### BACKGROUND

Field

Certain aspects of the present disclosure generally relate to machine learning and, more particularly, to improving systems and methods of motion planning.

Background

It is desirable for autonomous systems, such as robots, to have the ability to make decisions in view of uncertainty. For example, when operating in an unknown environment, it is desirable to determine a plan for controlling the robot to move from a location in the environment toward a goal or target destination while avoiding obstacles. However, determining such a plan is computationally intensive and expensive.

### SUMMARY

In an aspect of the present disclosure, a method of motion planning for an agent to reach a target is presented. The method includes determining a frontier region between a frontier at a current time and a frontier at a next time. The method also includes sampling waypoints in the frontier region with a bias toward the target. The method further includes selecting a path based on a sequence of the sampled waypoints.

In another aspect of the present disclosure, an apparatus for motion planning for an agent to reach a target is presented. The apparatus includes a memory and at least one processor. The one or more processors are coupled to the memory and configured to determine a frontier region between a frontier at a current time and a frontier at a next time. The processor(s) is(are) also configured to sample waypoints in the frontier region with a bias toward the target. The processor(s) is(are) further configured to select a path based on a sequence of the sampled waypoints.

In yet another aspect of the present disclosure, an apparatus of motion planning for an agent to reach a target is presented. The apparatus includes means for determining a frontier region between a frontier at a current time and a frontier at a next time. The apparatus also includes means for sampling waypoints in the frontier region with a bias toward the target. The apparatus further includes means for selecting a path based on a sequence of the sampled waypoints.

In yet still another aspect of the present disclosure, a non-transitory computer readable medium is presented. The a non-transitory computer readable medium has encoded thereon program code for motion planning for an agent to reach a target. The program code is executed by a processor and includes program code to determine a frontier region between a frontier at a current time and a frontier at a next time. The program code also includes program code to sample waypoints in the frontier region with a bias toward the target. The program code further includes program code to select a path based on a sequence of the sampled waypoints.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3 is a block diagram illustrating an exemplary architecture of an agent configured for motion planning in accordance with aspects of the present disclosure.

FIGS. 4A-4B are exemplary diagrams illustrating motion planning in accordance with aspects of the present disclosure.

FIG. 5 is an exemplary diagram illustrating frontier-based sampling in accordance with aspects of the present disclosure.

FIG. 6 is an exemplary diagram illustrating goal biased sampling in accordance with aspects of the present disclosure.

FIGS. 7 and 8 illustrate methods for motion planning according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Rapidly-Exploring Randomizing Feedback-Based Motion Planning

Aspects of the present disclosure are directed to motion planning for mobile robots and more particularly to motion planning in unknown environments. In some aspects, the motion planner may determine a policy for feedback control of an agent (e.g., robot) towards a goal while avoiding obstacles.

Aspects of the present disclosure may utilize intelligent sampling to determine a path for moving an agent, such as a mobile robot, in the environment from a current location to a goal or target destination. That is, unlike conventional sampling-based planners, sampling may be conducted differentially based on whether the region of the environment is known or unknown. For example, in some aspects, a known region may be densely sampled while a space or region that is unknown may be sparsely sampled.

Sampling points may be used to determine a route for moving the agent from its current location to the target destination. As the agent moves within the environment, more of the environment is observed and thus the known region expands. Having discovered more of the environment, it may be beneficial to update the route to the destination (e.g., the newly observed area reveals that an obstacle is in the path). Rather than discard the previously determined sampling points and resampling the environment, these sampling points may be preserved. Additional sampling may be conducted on a limited basis. For instance, additional sampling may be limited to a region near the boundary (or frontier) between the portion of the environment that is known (e.g., the portion observed or sensed by the agent) and the portion that is unknown. In some aspects, these samples or waypoints may only be inserted on the frontier. These waypoints may then be connected to the goal. In doing so, computational resources may be conserved by not putting samples in unknown regions of the environment (that the robot has never seen before). In some aspects, the sampling may be further limited by applying a bias for these waypoints in the direction of the goal. As such, computational resources may be conserved rather than resampling or taking more samples in the unknown region of the environment.

As the agent receives information about the environment, a graph, such as a rapidly-exploring randomizing graph (RRG), may be generated and maintained. The graph may be generated using the samples or nodes and connections between the samples, which may be referred to as edges.

A cost may be determined for movement within the environment toward the goal. For instance, a state cost may be determined for each of the samples or nodes. The state cost may define the cost associated with the agent being in a particular state (e.g., at the subject sample or node) within the environment. An edge cost may also be determined. The edge cost may define the cost of executing or moving along the edge or connection between samples. These costs may be maintained in the graph. In some aspects, the motion planner continuously updates the state costs and edge costs based on information about the environment (e.g., whether there is sufficient clearance, enough open space, whether a collision has occurred, and/or the degree to which the region is known or unknown). In this way, the motion planner may account for an instance in which there is certainty with respect to obstacles in the environment. For example, if an obstacle has been observed and certainty of the obstacle is high, then the cost associated with that state may likewise be high. On the other hand, if there is uncertainty with respect to whether an obstacle has been observed or not, then the cost may be set to a lower level than the case where certainty is high. Thus, the planner is not limited to merely considering validity (collision-free) or invalidity in collision cost, and as a result, improved planning may be achieved.

Using the graph and cost information, one or more control actions for moving the agent toward the goal or target destination may be determined. In some aspects, the control action may be the best or most efficient control action based on the information received.

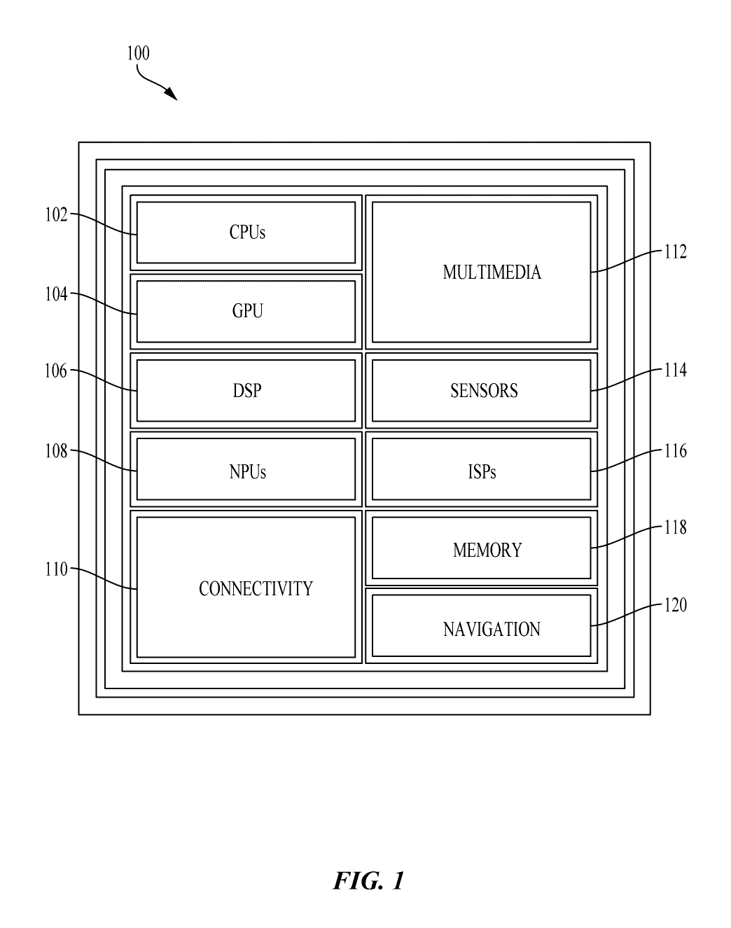

FIG. 1 illustrates an example implementation of the aforementioned motion planning using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code for determining a frontier region between a frontier at a current time, t, and a frontier at a next time, t+1. The instructions loaded into the general-purpose processor 102 may also comprise code for sampling waypoints in the frontier region with a bias toward the target. The instructions loaded into the general-purpose processor 102 may further comprise code for selecting a path based on a sequence of the sampled waypoints.

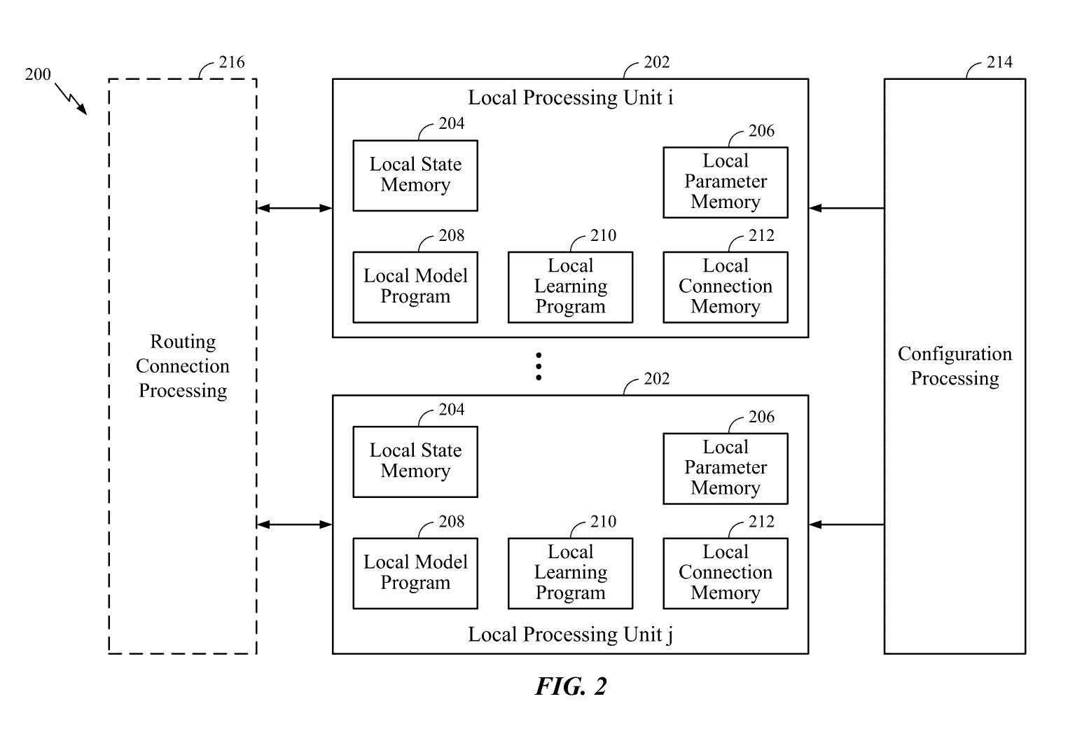

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

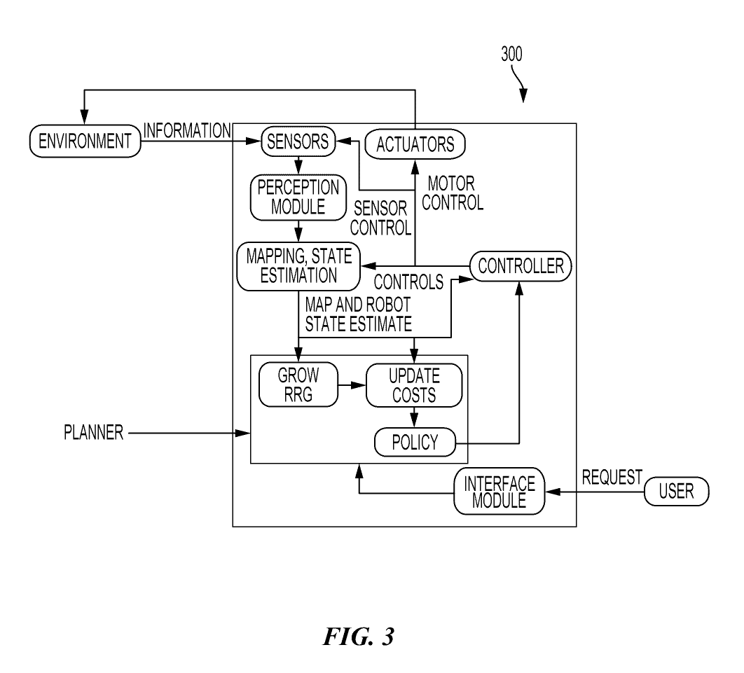

FIG. 3 is a block diagram illustrating an exemplary architecture for an agent 300 (e.g., robot) configured for motion planning, in accordance with aspects of the present disclosure. Referring to FIG. 3, the agent 300 includes sensors, which detect objects and other information about an environment. The detection information is supplied to a perception module. The perception module evaluates and/or interprets the detection information. The interpretation information may, in turn, be provided to a mapping and state estimation block. The mapping and state estimation block may utilize the interpretation information to determine or estimate a current state of the agent. For example, the mapping and state estimation block may determine the location of the agent within the environment. In some aspects, the mapping and estimation block may determine a map of the environment. In one example, the mapping and estimation block may identify obstacles and the position of such obstacles in the environment.

The map and/or state estimate may be provided to a planner. The planner may maintain a rapidly-exploring randomizing graph (RRG) based on the map and/or state estimate. In some aspects, the planner may grow the RRG. The planner may also determine and/or update a state cost. The state cost may comprise the cost of being in a particular state within the environment. Further, the planner may determine a next control action for the agent. In some aspects, the planner may determine multiple potential actions and may select an action among the actions that results in lowest state costs, closest proximity to the goal or destination.

In one configuration, a machine learning model is configured for determining a frontier region between a frontier at a current time and a frontier at a next time. The model is also configured for sampling waypoints in the frontier region with a bias toward the target. The model is further configured for selecting a path based on a sequence of the sampled waypoints. The model includes a determining means, sampling means, and/or selecting means. In one aspect, the determining means, sampling means, and/or selecting means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the model based upon desired one or more functional features of the model, and develop the one or more functional features the desired functional features as the determined parameters are further adapted, tuned and updated.

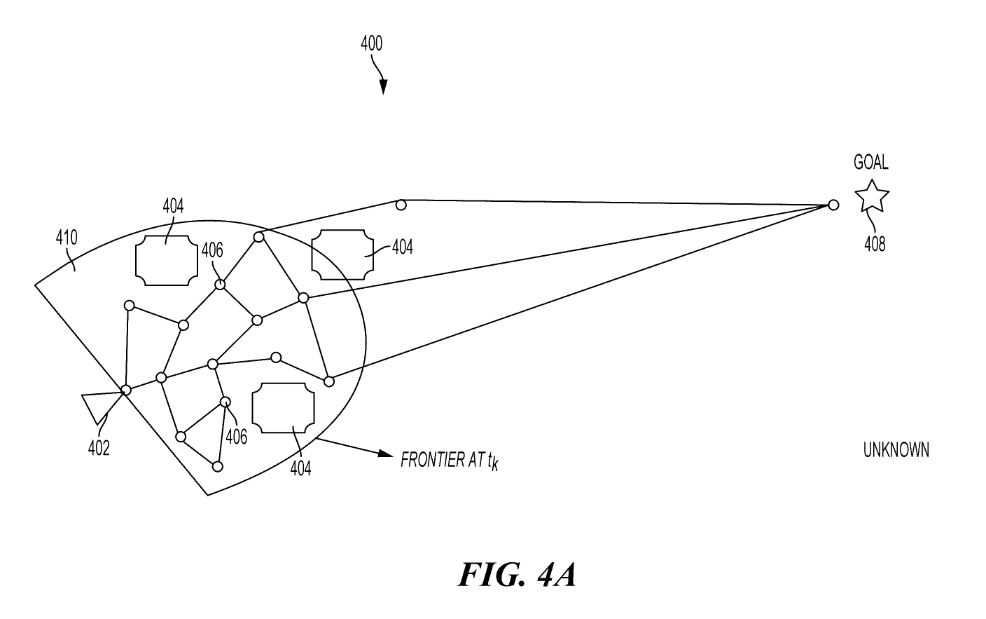

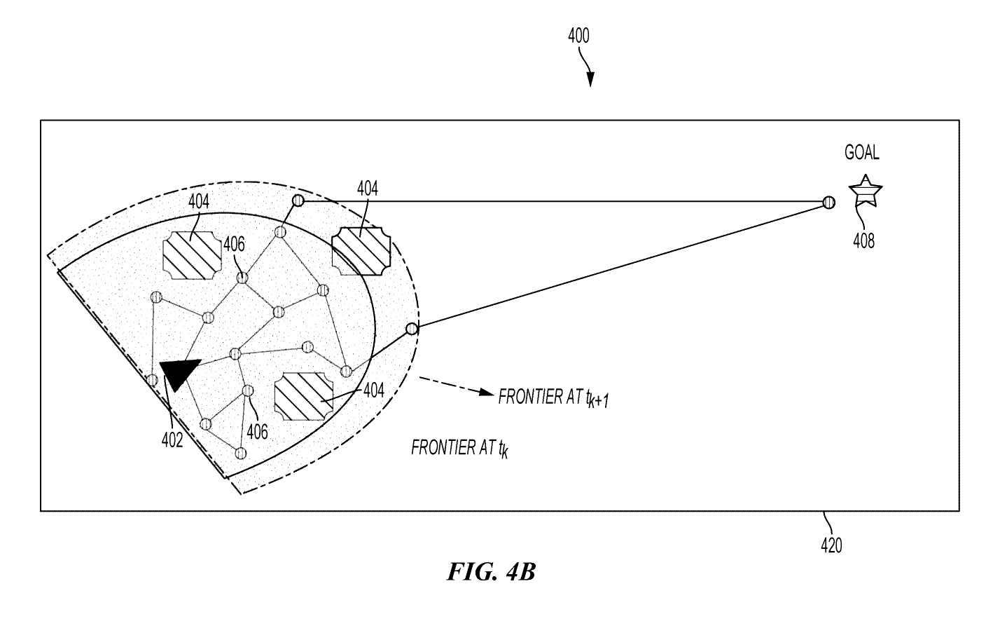

FIG. 4A is an exemplary diagram illustrating intelligent sampling in accordance with aspects of the present disclosure. Referring to FIG. 4A, an agent 402 is operating in an environment 400 with an objective of moving to a target or goal location 408. It is desirable to move the agent 402 from its current location to the goal location 408 while avoiding obstacles 404. A motion plan for moving the agent 402 may be determined, for example, by taking sampling points 406 (two such points are identified for ease of illustration) at various locations throughout a known region or observable region of an environment (e.g., region 410). For instance, a known region of an agent (e.g. region 410) may be defined by a viewing range or field of view (FOV) of a camera provided on or coupled to the agent 402. Of course, this is merely exemplary and other sensors or detection systems such as sound navigation and ranging (sonar), light detection and ranging (LIDAR) and the like may also be used to observe the environment.

In some aspects, the unknown region may also be sparsely sampled. Using the sampling points (e.g., sampling points 406), one or more paths or routes may be determined to move the agent 402 to the goal location.

In some cases, the goal location may be outside of the known or observable region of the agent. As shown in the example of FIG. 4A, the goal location 408 is beyond the observable or known region of the environment 400. That is, region 410 may comprise an observable range or range of perception for the agent 402 at time tₖ. The boundary between the known region 410 and the remainder of environment 400 (e.g., the unknown region) may define a frontier (e.g., frontier at tₖ). In one exemplary aspect, the frontier may be defined according to the pseudo code in Table 1, shown below. As seen in the exemplary pseudo code, at each azimuth and elevation relative to the agent (e.g., mobile robot), a voxel at a location specified by r, ψ, φ is examined to determine if the voxel is within the known region (map mₜₖ). If the voxel is within the known region (mₜₖ), the radius corresponding to the frontier may be increased until a voxel is found to be outside of the known region. Accordingly, the boundary or frontier may be defined based on the location of the last voxel within the known region. As the agent moves, the new region observed at time t+1 may be added to the frontier and a new frontier may be determined.

TABLE 1
Compute frontier region at time tₖ₊₁

Data: mₜₖ, mₜ_{ₖ₊₁}
Result: Frontier region at tₖ₊₁
Ψ = [ψ₀, ψ₁ ... ψ_{N}] ← discretize azimuth from 0 to 2π in N steps;
Φ = [φ₀, φ₁ ... φ_{N}] ← discretize elevation from 0 to 2π in N steps; [symbol]
ₜ_{ₖ₊₁} ← 0;
for ψ ε Ψ do

| \| | for φ ε Φ do | | |
|---|---|---|---|
| \| | \| | r_{ψ,φ,t}_{ₖ} ← 0; | |
| \| | \| | while voxel at (r_{ψ,φ,t}_{ₖ}, ψ, φ) is known in mₜ_{ₖ} do | |
| \| | \| | \| | r_{ψ,φ,t}_{ₖ} + +; |
| \| | \| | end | |
| \| | \| | r_{ψ,φ,t}_{ₖ₊₁} ← 0; | |
| \| | \| | while voxel at (r_{ψ,φ,t}_{ₖ₊₁}, ψ, φ) is known in mₜ_{ₖ₊₁} do | |
| \| | \| | \| | r_{ψ,φ,t}_{ₖ₊₁} + +; |

| | | |
|---|---|---|
| \| | \| | end |
| | | [symbol] ₜ_{ₖ₊₁} ← [symbol] ₜ_{ₖ₊₁} ∪ (ψ, φ, r_{ψ,φ,t}_{ₖ}, r_{ψ,φ,t}_{ₖ₊₁}); |

end

end
Return [symbol] ₜ_{ₖ₊₁};

As the agent 402 moves further into the environment 400 toward the goal location 408, the agent 402 is able to observe or view more of the environment 400. As such, the observed or known region expands and a new frontier may be determined. Referring to FIG. 4B, a second frontier, frontier at tₖ₊₁ is defined. Rather than discarding the previously determined sampling points 406 (e.g., within the known region at time tₖ) and resampling the newly defined known region (e.g., known region at time tₖ₊₁), in accordance with aspects of the present disclosure, the previously determined samples may be preserved. Additional sampling points may also be taken in the known region. In some aspects, the additional sampling points are only taken in a frontier region defined by the frontier at tₖ and the frontier at tₖ₊₁.

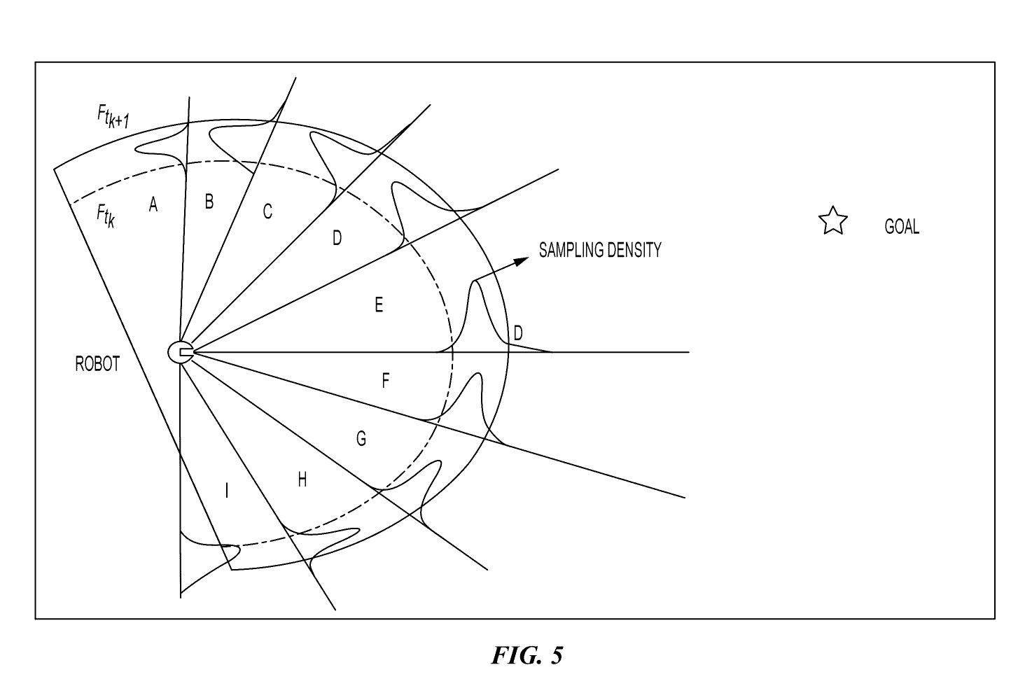

The additional sampling points may be randomly distributed. For instance, in the exemplary diagram of FIG. 5, additional sampling points are taken in the frontier region. The known region is divided into subregions A-I. Regions A-I each include a curve that illustrates the density of sampling in the region. As seen in FIG. 5, the sampling density is roughly the same in each subregion.

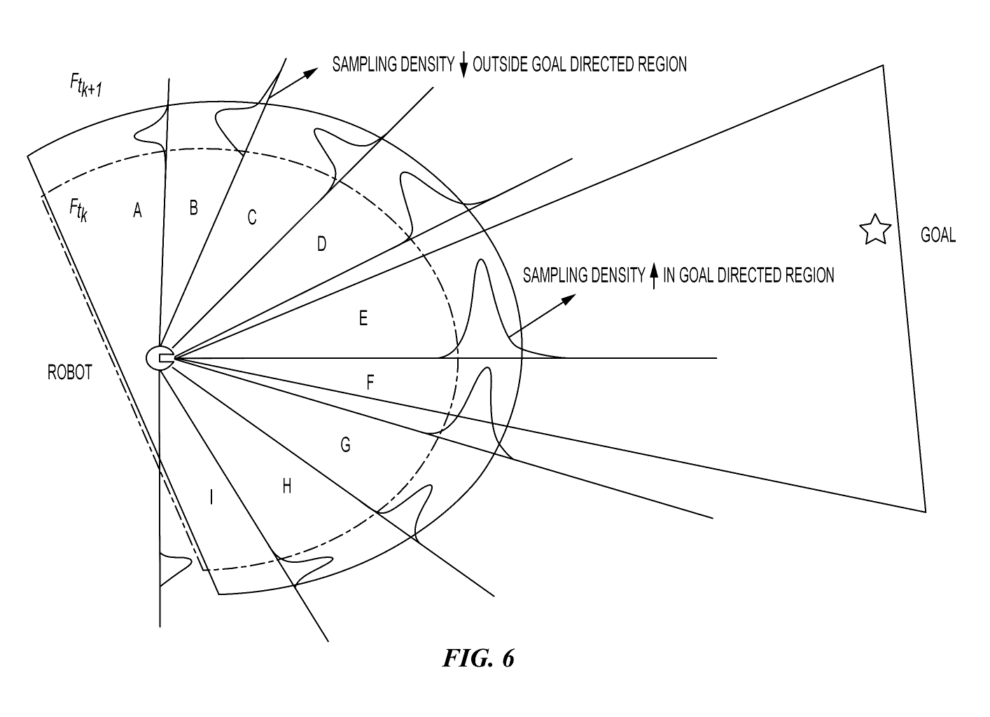

In some aspects, the distribution of the sampling points may be biased such that more sampling points are taken in an area that is in the direction of the goal location relative to the position of the agent. FIG. 6 is a diagram illustrating goal biased sampling. Referring to FIG. 6, the sampling density in the areas or subregions that are goal directed regions may be greater than the sampling density in other regions. The goal directed region may be defined by a cone between the agent and the goal location. In this example, subregions E and F fall within the goal directed cone. As such, the sampling density in subregions E and F is greater than the sampling density of the remaining subregions. Further, because a larger portion of subregion E is within the goal directed cone than subregion F, more sampling points will be taken in subregion E than are taken in subregion F. The other regions have a lower sampling density as they become farther from the goal directed cone, as represented by the curves shown in each region.

In some aspects, the goal bias from the agent to goal location may be determined by defining innovation between the azimuth and elevation from the goal and sample state as:

[ψ_{goal},φ_{goal}]^{T}−[ψₛₐₘₚₗₑ,φₛₐₘₚₗₑ]^{T}

where ψ_{goal},φ_{goal} is a vector defining the azimuth and elevation from the agent to the goal and ψₛₐₘₚₗₑ,φₛₐₘₚₗₑ is a vector defining the azimuth and elevation from the agent to a sample.

In some aspects, a likelihood of a sample lying within a cone to goal may be computed, for example, according to a Gaussian function given by:

$$β = {{e}^{\frac{- 1}{2}} ( {[ {ψ}_{goal} , {φ}_{goal} ]}^{T} - {[ {ψ}_{sample} , {φ}_{sample} ]}^{T} )}^{T} {\sum }^{- 1} ( {[ {ψ}_{goal} , {φ}_{goal} ]}^{T} - {[ {ψ}_{sample} , {φ}_{sample} ]}^{T} )$$

$$\sum = diag ( [ {σ}_{ψ} , {σ}_{φ} ] )$$

where σ_{ψ},σ_{φ} are user defined standard deviations for the variance in sampling across the azimuth and elevation. The smaller these standard deviations are, the narrower the goal directed cone (e.g., sampling region) becomes.

If the likelihood of a sample being in the cone to goal exceeds a threshold value, then the sample may be retained. Otherwise, the sample may be discarded. In some aspects, a certain number of samples for which the likelihood of lying within the cone to goal is below the threshold may be retained.

Table 2 includes exemplary pseudo code for determining a sampling point or waypoint in accordance with aspects of the present disclosure.

TABLE 2
Compute new sample

Data: mₜ - map at time t
Result: Sample
acceptSample ← False;
xₛₐₘₚₗₑ ← 0
while !acceptSample do

| \| | x_{rand} ← sample state space uniformly; | |
|---|---|---|
| \| | mⁱ ← compute which voxel x_{rand} lies in mₜ; | |
| \| | σ_{θ}_{ⁱ} ← compute voxel mⁱ occupancy variance; how certain is | |
| \| | occupancy? | |
| \| | β ← compute likelihood that voxel is in cone to goal; | |
| \| | if sample lies in frontier and β ≧ β_{threshold} then | |
| \| | \| | accept Sample ← True; |
| \| | \| | xₛₐₘₚₗₑ ← x_{rand}; |

end

end
Return xₛₐₘₚₗₑ ; the number of samples is not limited, rather the time to
sample is limited

Having determined a set of samples, one or more routes for moving the agent from a current location to the goal may be determined. In some aspects, the shortest route to the goal may be used to determine a control action to move the agent to the goal.

In some aspects, a cost for each of the routes may be determined and used to select a route to the goal location. A state cost or a cost for the agent being in a state (e.g., at a particular sampling point) may be determined. An additional cost or penalty may be included based on whether the point is in a known region. For instance, an additional cost may be included where the point is in the unknown region where variance is higher (e.g., less confident about the presence of an obstacle at the location of the sample in the unknown region). Table 3 includes exemplary pseudo code that may be used to compute the state cost.

TABLE 3
Compute state cost

Data: mₜ, e - where e is an edge
Result: state cost
i ← global index of voxel in which x resides;
if i - th voxel is known then;

| | |
|---|---|
| \| | Cᵥ(x) ← γ_{clearance}; Cost of being at a vertex x set according to the |

voxel clearance, which is amount of empty space around a voxel
end
else

| | |
|---|---|
| \| | Cᵥ(x) ← user defined cost for unknown voxel + γ_{clearance}clearance ; |

add cost if in unknown region
end

In addition, an edge cost or cost of executing a control action for moving along a connection between states (e.g., sampling points) is calculated. For example, the edge cost may be computed as shown in Table 4.

TABLE 4
Compute edge cost

Data: mₜ, e - where e is an edge
Result: edge cost
U ← compute open loop controls to guide state from e_{source} to e_{target} ;
x₀ ← e_{source} ; start state
cost ← 0 ;
for uₖ ε U do

| | |
|---|---|
| \| | xₖ₊₁ ← propagate xₖ ; |
| \| | cost ← cost + cost of state xₖ₊₁ + γ_{control}uₖ ; |

end
Return cost ;

Using the state costs and the edge costs, a route may be selected for moving the agent from a current location to the goal location. Corresponding control action may be determined for controlling the agent to move along the selected route to the goal location.

Furthermore, as the agent moves within and/or observes more of the environment, the graph corresponding to the environment may expand. For example, additional sampling points or nodes and connections there between may be included in the graph. The costs (e.g., state costs and edge costs) may be maintained in a graph such as a rapidly-exploring randomizing graph (RRG). Table 5 includes exemplary pseudocode for growing an RRG.

TABLE 5
Grow Map Aware RRG

Data: mₜ, xₛₜₐᵣₜ, x_{goal}
Result: path [symbol]
← ; [symbol] ← [symbol] ∪ {xₛₜₐᵣₜ, x_{goal}} ; [symbol]
← ;
while not reached goal do

| \| | x_{rand} ← sample goal biased point on map frontier ; | |
|---|---|---|
| \| | xₙₑₐᵣₑₛₜ ← find node in [symbol] = ( [symbol] , [symbol] ) nearest to x_{rand}; | |
| \| | x_{new} ← steer from xₙₑₐᵣₑₛₜ to x_{rand}; | |
| \| | Xₙₑₐᵣ ← find nearest neighbors of x_{new} in [symbol] ; | |
| \| | [symbol] ← [symbol] ∪ {x_{new}} ; | |
| \| | Cᵥ(x_{new}) ← compute state cost; | |
| \| | [symbol] ← [symbol] ∪ {(xₙₑₐᵣₑₛₜ, x_{new}), (x_{new}, xₙₑₐᵣₑₛₜ)}; | |
| \| | Cₑ(xₙₑₐᵣₑₛₜ, x_{new}) ← compute edge cost ; | |
| \| | Cₑ(x_{new}, xₙₑₐᵣₑₛₜ) ← compute edge cost ; | |
| \| | for xₙₙ ε Xₙₑₐᵣ do | |
| \| | \| | [symbol] ← [symbol] ∪ {(xₙₙ, x_{new}), (x_{new}, xₙₙ)}; |

| | |
|---|---|
| \| | end |
| \| | [symbol] ← [symbol] ∪ {(x_{new}, x_{goal})} ; |

end

The RRG may be updated as the agent moves toward the goal. As shown in the pseudo code of Table 6, the graph may be expanded as more of the environment is observed and becomes known. The graph may be grown from the starting location of the agent to the goal or target destination. While the target has not been reached, the process samples goal biased points on the map frontier (or in the frontier region). A nearest neighbor in the graph G to a newly sampled point is determined. Connections between (E—edges and V—vertices) the nearest neighbor and the newly sampled point may also be determined. In some aspects, the newly sampled point (x_{rand}) may not be reachable in a time step, so a closer sample x_{new} may be used for mapping purposes. Accordingly, connections to x_{new} may be determined. In turn, state and edge costs may be computed and saved. Notably, collision checks are not performed because there is no concept of validity. Rather, aspects of the present disclosure utilize edge and state costs. Dynamic programming (DP) may be used in the solution. The best neighbors, D, are kept to limit complexity. The set of edges, E, does not include the edges that are not the best neighbors, D.

TABLE 6
Update Map Aware RRG Costs

| Data: mₜ, [symbol] = ( [symbol] , [symbol] ) | | |
|---|---|---|
| Result: costs | | |
| C_{g}(x_{goal}) ← 0 ; | | |
| X_{FOV} ← find graph vertices in sensor FOV ; | | |
| For x ε X_{FOV} do | | |
| \| | Cᵥ(x) ← update state cost ; | |
| \| | for e ε edges of x and e not already updated do | |
| \| | \| | Cₑ(e) ← compute cost of edge e; |
| \| | end | |
| end | | |
| Solve reverse DP-update optimal cost-to-reach; | | |
| Solve DP update optimal cost-to-go; | | |
| for x ε X_{FOV} do | | |
| \| | Xₙₑₐᵣ ← find nearest neighbors of x in [symbol] ; | |
| \| | for xₙₙ ε Xₙₑₐᵣ do | |
| \| | \| | Cᵣ(xₙₙ, x) ← cost-to-reach x through xₙₙ ; |

| | |
|---|---|
| \| | end |
| \| | D ← d-best neighbors with lowest Cᵣ(xₙₙ, x); |
| \| | [symbol] ← [symbol] \ ∪_{x′εX}_{ₙₑₐᵣ}_{\D}(x′, x); |

end

A cost for each of the samples (state cost) and the connections there between (edge costs) may be determined. In some aspects, only the d-best edges (where d is an integer number) may be maintained to limit the complexity of the graph. The d-best edges may comprise edges having the lowest cost to reach node x (Cᵣ). These costs may be used to determine one or more control actions to move the agent toward the goal.

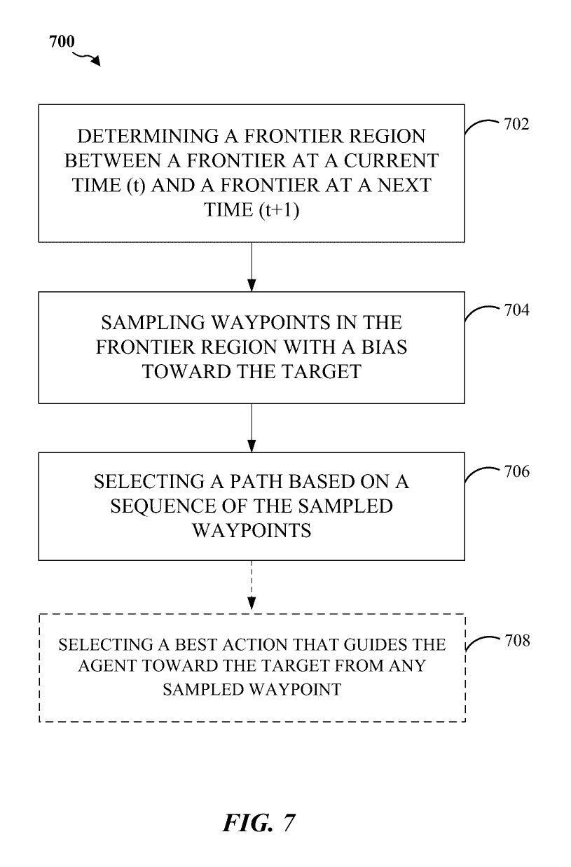

FIG. 7 illustrates a method 700 for motion planning for an agent to reach a target. In block 702, the process determines a frontier region between a frontier at a current time (t) and a frontier at a next time (t+1).

In block 704, the process samples waypoints in the frontier region with a bias toward the target. In some aspects, the bias may be defined as a cone between the agent (e.g., robot or a car) and the target. Further, the process may conduct more sampling in a region where the cone intersects the frontier region.

In block 706, the process selects a path based on a sequence of the sampled waypoints. In some aspects, the process may optionally select a best action that guides the agent toward the target from any sampled waypoint, in block 708. In some aspects, the best action is an action that produces a motion along a path having a shortest distance to the goal, an action that produces a motion along a path having a shortest time to travel to the target or the like.

The process may further define a state cost based on whether a waypoint is in a known region or an unknown region. The process may also define an edge cost based on an amount of clearance around an edge and an amount that passes through the known region (low cost) or unknown region (high cost). The state costs and edge (connection between two waypoints) costs may be updated continuously. Furthermore, the selected path may be updated based on the updated state costs and edge costs.

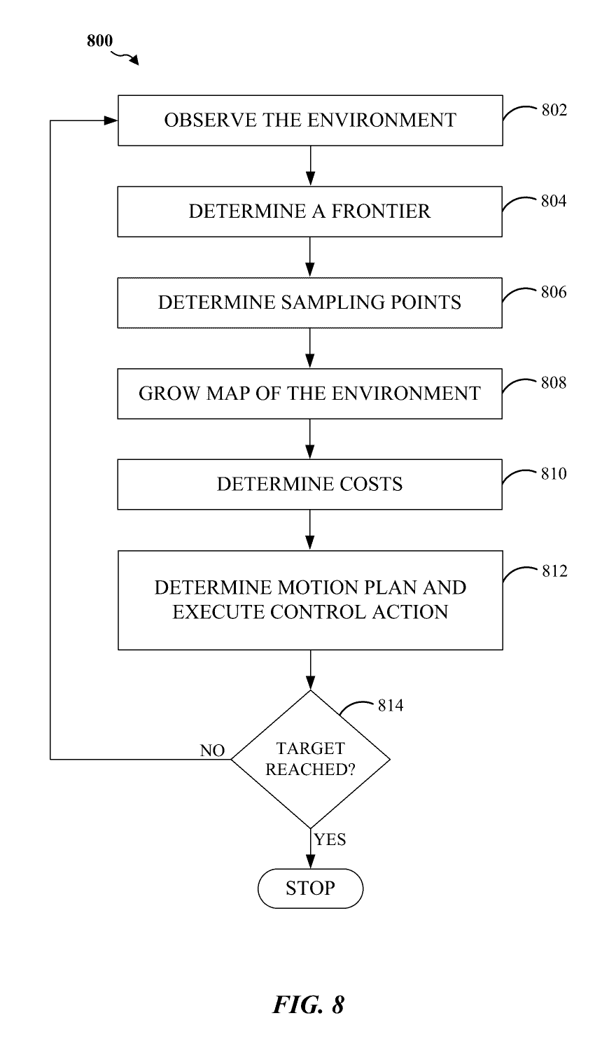

FIG. 8 is a block diagram illustrating a method 800 for motion planning for an agent to reach a target, in accordance with aspects of the present disclosure. In block 802, the agent observes the environment. The agent may observe the environment, for example via a camera, sonar, LIDAR, or other sensor or detection system. In block 804, the process determines a frontier. The frontier may comprise the boundary between the observed or known region and the unknown region.

In block 806, the process determines sampling points. In some aspects, sampling points may be randomly distributed throughout the known region while the unknown environment may be sparsely sampled.

In block 808, the process may grow a map of the environment. The map may comprise a rapidly-exploring randomizing graph.

In block 810, the process may determine costs associated with one or more routes or paths from the agent location to the target or goal. The costs may include state costs and edge costs. The state cost may comprise the cost of being at the position of a sampling point, which may be referred to as a node. In some aspects, the cost may be based on the region of the sample. For instance, a cost may be greater for a node in the unknown region than for a node in the known region at a given time.

An edge may comprise the connection between sampling points or nodes. An edge cost is the cost associated with traversing an edge. The cost of an edge may similarly be determined based on the location of the edge. For instance, the cost of an edge in the unknown region may be greater than an edge in the known region.

In block 812, the process may determine a motion plan for moving the agent to the goal or target location. One or more routes may be determined. A cost for each of the routes may be determined and may be used to select a route. Further, a control action may be determined and executed to move the agent according to the selected route.

In block 814, the process evaluates whether the target destination has been reached. If the target has not been reached, the process may return to block 802 to observe the environment as the robot moves in the next time step. In block 804, a next frontier may be determined.

Notably, in the subsequent iterations of the process, at block 806, the process may again determine sampling points. However, in some aspects, the process may retain the previously determined sampling points in the known region. Additional sampling point may be determined within a region defined by current frontier (tₖ+1) and the previous frontier (tₖ).

In some aspects, the sampling may be further biased in the direction of the target or goal relative to the agent. The bias may be defined as a cone between the agent (e.g., robot or a car) and the target. Further, the process may conduct more sampling in a region where the cone intersects the frontier region.

The map and costs may be updated (blocks 808 and 810) and a motion plan may be determined (block 812) based on the updated map and cost information. Finally, when the target or goal location has been reached (814:YES), the process stops.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

In some aspects, methods 700 and 800 may be performed by the SOC 100 (FIG. 1) or the system 200 (FIG. 2). That is, each of the elements of methods 700 and 800 may, for example, but without limitation, be performed by the SOC 100 or the system 200 or one or more processors (e.g., CPU 102 and local processing unit 202) and/or other components included therein.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the models and systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of motion planning for an agent to reach a target, comprising:
determining a frontier region between a frontier at a current time and a frontier at a next time;
sampling waypoints in the frontier region with a bias toward the target; and
selecting a path based on a sequence of the sampled waypoints.

2. The method of claim 1, in which more sampling occurs in a region where a bias cone intersects the frontier region, where the bias cone is defined as a cone between the agent and the target.

3. The method of claim 1, further comprising:
defining a state cost based on whether a waypoint is in a known region or an unknown region;
defining an edge cost based on an amount of clearance around an edge and an amount that passes through the known region or the unknown region; and
selecting the path based on the edge cost and the state cost.

4. The method of claim 3, further comprising:
continuously updating the state cost and the edge cost; and
updating the selected path based on the updated state cost and the updated edge cost.

5. The method of claim 1, further comprising selecting a best action that guides the agent toward the target from any sampled waypoint.

6. An apparatus for motion planning for an agent to reach a target, comprising:
a memory; and
at least one processor coupled to the memory, the at least one processor configured:
to determine a frontier region between a frontier at a current time and a frontier at a next time;
to sample waypoints in the frontier region with a bias toward the target; and
to select a path based on a sequence of the sampled waypoints.

7. The apparatus of claim 6, in which the at least one processor is further configured to sample more waypoints in a region where a bias cone intersects the frontier region than other regions, where the bias cone is defined as a cone between the agent and the target.

8. The apparatus of claim 6, in which the at least one processor is further configured:
to define a state cost based on whether a waypoint is in a known region or an unknown region;
to define an edge cost based on an amount of clearance around an edge and an amount that passes through the known region or the unknown region; and
to select the path based on the edge cost and the state cost.

9. The apparatus of claim 8, in which the at least one processor is further configured:
to continuously update the state cost and the edge cost; and
to update the selected path based on the updated state cost and the updated edge cost.

10. The apparatus of claim 6, in which the at least one processor is further configured to select a best action that guides the agent toward the target from any sampled waypoint.

11. An apparatus for motion planning for an agent to reach a target, comprising:
means for determining a frontier region between a frontier at a current time and a frontier at a next time;
means for sampling waypoints in the frontier region with a bias toward the target; and
means for selecting a path based on a sequence of the sampled waypoints.

12. The apparatus of claim 11, in which the sampling means samples more in a region where a bias cone intersects the frontier region, where the bias cone is defined as a cone between the agent and the target.

13. The apparatus of claim 11, further comprising:
means for defining a state cost based on whether a waypoint is in a known region or an unknown region; and
means for defining an edge cost based on an amount of clearance around an edge and an amount that passes through the known region or the unknown region,
in which the means for selecting the path selects the path based on the edge cost and the state cost.

14. The apparatus of claim 13, further comprising:
means for continuously updating the state cost and the edge cost; and
means for updating the selected path based on the updated state cost and the updated edge cost.

15. The apparatus of claim 11, further comprising means for selecting a best action that guides the agent toward the target from any sampled waypoint.

16. A non-transitory computer readable medium having encoded thereon program code for motion planning for an agent to reach a target, the program code being executed by a processor and comprising:
program code to determine a frontier region between a frontier at a current time and a frontier at a next time;
program code to sample waypoints in the frontier region with a bias toward the target; and
program code to select a path based on a sequence of the sampled waypoints.

17. The non-transitory computer readable medium of claim 16, further comprising program code to sample more waypoints in a region where a bias cone intersects the frontier region than other regions, where the bias cone is defined as a cone between the agent and the target.

18. The non-transitory computer readable medium of claim 16, further comprising:
program code to define a state cost based on whether a waypoint is in a known region or an unknown region;
program code to define an edge cost based on an amount of clearance around an edge and an amount that passes through the known region or the unknown region; and
program code to select the path based on the edge cost and the state cost.

19. The non-transitory computer readable medium of claim 18, further comprising:
program code to continuously update the state cost and the edge cost; and
program code to update the selected path based on the updated state cost and the updated edge cost.

20. The non-transitory computer readable medium of claim 16, further comprising program code to select a best action that guides the agent toward the target from any sampled waypoint.
